(19) United States
(12) Patent Application Publication
(10) Pub. No.: US 2003/0013034 A1
(43) Pub. Date: Jan. 16, 2003

(54) Process and device for fusing toner onto a carrier medium or print substrate

(76) Inventors: Knut Behnke, Kiel (DE); Hans-Otto Krause, Eckernforde (DE); Frank-Michael Morgenweck, Molfsee (DE); Domingo Rohde, Kiel (DE); Detlef Schulze-Hagenest, Molfsee (DE); Gerhard Bartscher, Koln (DE); Kai-Uwe Preissig, Dortmund (DE); Dinesh Tyagi, Fairport, NY (US)

Correspondence Address: Lawrence P. Kessler, Patent Department, NexPress Solutions LLC, 1447 St. Paul Street, Rochester, NY, 14653-7103, US

(21) Appl. No.: 10/011,384

(22) Filed: Dec. 4, 2001

(30) Foreign Application Priority Data
Dec. 22, 2000 (DE) 100 64 565.8
Sep. 12, 2001 (DE) 101 45 005.2

(51) Int. Cl. G03G 13/20; G03G 15/20

(52) U.S. Cl. 430/124; 399/336

(57) ABSTRACT

A process and device for fusing toner onto a carrier or a print substrate, in particular a sheet-like print substrate, preferably for a digital printing machine, wherein the toner bearing print substrate is heated by microwaves emanating from at least one microwave emitter in order to melt the toner, and wherein a toner is used that demonstrates a sharp drop-off in the elastic module G′ from its solid to its liquid state upon heating. The ratio of the elastic module G′ of the toner at the reference temperature, calculated from the initial temperature at the start of the glass transition of the toner plus 50° C., to the value of the elastic module G′ at the initial temperature itself is preferably <10⁻⁵.

### FIELD OF THE INVENTION

The present invention concerns a process for fusing toner onto a carrier medium or print substrate, especially in sheet or tape form, preferably for a digital printing machine.

In addition the invention concerns a device for fusing toner onto a carrier medium or print substrate, especially in sheet or tape form, preferably for a digital printing machine/printer, preferably for implementation of the above-mentioned process.

### BACKGROUND OF THE INVENTION

Digital printing, especially electrostatic or electrophotographic printing, creates a latent electrostatic image that is developed by charged toner particles which in turn are transferred to a print substrate that receives the image, e.g. paper. The image transferred to the print substrate is then fused thereon by heating or softening of the toner and/or heating of the print substrate. Throughout and by this process, toner particles combine with the print substrate and if applicable with each other.

Prior art in principle reflects the use of microwaves for fusing the toner to the print substrate. Since the absorption of microwave energy in the toner is usually at least one magnitude smaller than in the print substrate, in preferred embodiments the print substrate is heated by the microwaves and, in turn, heats the toner on it to a temperature at which the toner binds with the print substrate. Prior art reflects that when utilizing microwaves for fusing toner, the characteristics of the print substrate used, such as weight, humidity and composition, are critical and must be taken into account.

This prior art includes U.S. Pat. No. 4,511,778, which proposes an image-fusing device that fuses an image from toner using high frequency waves, in particular microwaves, onto a print substrate, in particular a sheet of paper. One aspect of this prior art device is the possibility to release microwaves as a function of the size of the print substrate, in order to ensure, by taking into account the size as a characteristic value of the print substrate, the appropriate melting and fusing of the toner. This procedure is quite general and only takes into account the immediately apparent size of the print substrate and presetting it for operation of the device prior to fusing, somewhat following the thought that a larger piece of material to be heated will, due to its larger heat capacity, require more total energy than a smaller one.

However, this default setting leaves other critical aspects of the use of microwaves in the fusing of toner unaccounted for. Thus, for example, the above-mentioned procedure can only be used in black and white printing with a narrow range of paper weights. The potentially differing performance characteristics of various color toners and various paper weights, with, additionally, potentially differing humidity contents cannot be taken into account with this default procedure geared to the size of the print substrate. In a color print, for example, the toner image can consist of four different layers of toner, where the maximum density of each layer of toner on the image carrier substrate and/or print substrate is 100%, resulting in a maximum total toner layer density in the toner image of 400%. Generally the density of a single color toner image is in the range of 0-100%, and that of a color toner image in the range of 0-290%. In addition, the procedure referred to does not include any microwave resonator known from prior art which would appear to be desirable in regard to homogenous heating when using microwaves.

Furthermore, the use of sheet-like printing material can present the problem that, in the area radiated with microwaves, the border portion of the sheet receives a different energetic treatment from that of the center area of the sheet, thus resulting in an unevenly printed product. Another factor is that, when fusing standard toner exclusively by microwaves, under certain conditions only an incomplete melting of the toner can be obtained, depending on its layer thickness, or that formation of hot spots with attendant blistering occurs in certain areas of the toner. Toner adhesion to the print substrate can in certain circumstances also be insufficient, because, for example, the toner does not sufficiently combine with the print substrate due to excessive viscosity of the molten toner Problems are likely especially when a print substrate is printed on both sides in two printing runs following upon each other. Owing to the potential problems described, microwave radiation is not normally relied upon for fusing, but rather, in practice, the toner is heated without the use of microwaves, and combined with the print substrate through pressurization by heated rollers. However, contact-less fusing is essentially desirable to protect the quality of the printed image. Other advantages of contact-less fusing are the avoidance of adhesive wear and tear and of the consequent downtime of the equipment used, as well as its increased reliability.

### SUMMARY OF THE INVENTION

The fundamental task of the invention is therefore to enable adequate fusing of toner onto a print substrate by microwaves, preferably also for multicolor printing onto sheet-like print substrates and by the use of a resonator and preferably by adaptation to the special conditions involved. This task is resolved in the invention from the procedural point of view by the fact that the print substrate registering the presence of toner is irradiated with microwaves from at least one microwave emitter and is heated in order to melt the toner, and that the toner used demonstrates a sharp transition from its solid to its liquid state when heated.

In this manner the invention enables use of a dry toner that at a temperature of between 50° C. and 70° C. is still rather hard, so that it may be ground by conventional processes to a mean toner size of e.g 8−4 micrometers and that will also not become sticky or melt at development temperatures, but that at a higher temperature of 90° C. will already be quite liquid and show low viscosity. Thus, by capillarity such toner will, even without external pressure or contact, adhere to and deposit itself onto the print substrate and upon cooling will very quickly harden again and fuse, with an appropriate surface gloss matching the underlying print substrate, in particular due to the absence of well-developed grain borders. The latter element is also particularly important in connection with color toner for color saturation.

In this respect, in connection with the toner according to the invention, the relationship between the value of the elastic module G′ at the reference temperature value, calculated from the initial temperature at the beginning of the glass transition of the toner plus 50° C., to the value of the elastic module at the starting temperature itself can be <1 E-5, preferably even <1 E-7, where E stands for the decimal exponent. The initial toner glass transition temperature is preferably determined as being that value at which the tangents to the function of the elastic module G′ determined by the temperature functions before and after the glass transition point intersect. The toner's transition from its solid to its liquid state shall preferably take place in a temperature interval or window of between 30 and 50° C. This window should be above 60° C. and preferably between approximately 70° C. and 130° C., and most preferably between 75° C. and 125° C.

A further development of the process according to the invention is characterized by its adaptation to special circumstances by the fact that at least one physical procedural parameter is controlled and/or regulated as a function of one parameter correlated with the energy input into the print substrate carrying the toner. Therefore, according to the present invention, no default setting is envisaged, but, rather, and preferably, a regulation adapted to actual, preferably measured conditions. The above-mentioned energy input can substantially correspond to a microwave output absorbed by the overall system of print substrate and toner, so that, in accordance with the invention and corresponding to actual conditions, the energy output and input are compared and adapted to each other. This in turn corresponds substantially to a coefficient control and/or setting, and also generally includes the possibility of regulation on the emitter side, in the broadest sense, which can also be termed the microwave source, and/or on the side of the receiving toner/print substrate system, or its management.

In this connection the invention preferably proposes, in detail, to regulate the output of the microwave source, and/or the speed of movement of the print substrate, and/or to adapt the resonator and/or the microwave frequency. The latter two measures are regulated preferably also in order to achieve higher immediate energy absorption in the toner itself, thus more accurately influencing its melting than would be the case indirectly via the print substrate, which presents a more complex proposition. The measurable parameters for dependent regulation proposed by the invention are preferably the temperature of the print substrate or the microwave energy reflected and therefore not absorbed by the system formed by the toner and the print substrate. Other measurable parameters can, by way of example but without limitation, be the weight/thickness or the humidity content of the print substrate, or the density and gloss of the toner layer.

In principle, any frequency in the microwave range between 100 MHz and 100 GHz can be used. Generally the ISM frequencies released for industrial, scientific or medical use, preferably 2.4 GHz, will be used. However, use of other frequencies in the above-mentioned broad frequency range can advantageously lead to a greater proportion of the radiation energy than normal being absorbed by the toner and not the print substrate.

Another development of the device according to the invention is characterized by at least one resonator for the microwaves emitted by the microwave source, generating a standing microwave approximately perpendicularly to the plane of the print substrate. A vertically arranged resonator of this type has the advantage that it provides a particularly favorable intensity distribution of the electrical field in the print substrate plane. For it can be accomplished that a highly homogeneous intensity of the electrical field is generated over a resonator width selected to be relatively reduced in the plane of the print substrate and transversally to its direction of transport and thus the print substrate and/or the toner carried by it is evenly heated over this width and, with even propulsion of the print substrate in the direction of transport, also over its length. Therefore, with a resonator according to the invention, it is possible to process a strip of a width corresponding to the resonator width that is sequentially and uniformly heated over time, over the length of the print substrate.

A further development of the invention involves the inclusion of more than one resonator and a distributive arrangement of resonators over the width of the print substrate, with the operating widths of adjacent resonators preferably, and as a precautionary measure, overlapping one another so that the print substrate and the toner carried thereon are fully and completely uniformly heated over the entire area of the print substrate. In so doing, as stated before, it is preferably ensured that the resonator delivers as homogeneous as possible an electrical field over its entire width, which is particularly well accomplished with a resonator width of up to approximately 20 cm, while the preferred resonator width is of between approximately 4 and 8 cm.

The resonators are preferably arranged offset to each other, allowing for different configurations. For example, the resonators could be arranged in two rows in the respective gaps left by the preceding row, which results in a compact, space-saving arrangement. However, the resonators can also be arranged in a step design or a V-shape. These configurations have the advantage that the toner in the overlap areas of the operating widths of the resonators will not cool down while passing between subsequent resonators. This prevents the occurrence of a potentially visible border layer formation due to repeated melting of the toner layer in the overlap areas. In addition, the above-mentioned configurations have the advantage of allowing for enough space for guide elements for the print substrate within the device according to the invention.

In principle, all existing resonators can be supplied through one unique microwave source. The energy can be distributed among the various systems by T-pieces, for example. Homogeneous heating of the image to be fused can, however, be ensured more reliably if each resonator is supplied from its own individual microwave source. Thus, differing heating of the image to be fused, caused by differing degrees of fill of the resonators in the border area of the print substrate, can be compensated by appropriate adjustment of the microwave output of the respective resonator, by adapting the microwave output to the relevant degree of fill of each resonator.

A practical minimization of the number of microwave sources can however still be achieved if the output of each microwave generator is distributed by T-pieces to two resonators, while preferably ensuring that both resonators linked with each other have approximately the same degree of fill. For example, in a series of four resonators arranged over the width of the print substrate, the two central resonators and the two outer resonators could be connected with each other, as each pair possesses a symmetrical degree of fill in relation to a symmetry axis existing between the two inner resonators. This enables a 50% reduction in the microwave sources or magnetrons.

In the separation plane of the relevant resonator, through which the print substrate is transported and which therefore corresponds to the print substrate plane, no or only minor transversal flows take place on the internal resonator chamber wall, so that no high degree of scattered radiation occurs. A suitable conductive connector can be used in order to create an electrical contact between the relevant resonator component areas (half shells). However, connectors can be difficult to implement from a geometrical point of view when several resonators are arranged next to one another. It can therefore be advisable to bring about the electrical contact by connectors interconnected in an appropriate manner. Such interconnection does not affect the individual resonators. Special attention should be paid to ensure that the junction contact points are positioned in locations at which high current density is present on the interior of the resonators.

Independent adjustment of the individual resonators to maximum absorption could, in certain circumstances, not lead to satisfactory results. The fusing result could be uneven. Print substrate absorption in the subsequent resonators could therefore be optimized by the use of prior resonators in order to obtain an even fusing outcome. The scattered radiation exiting the resonators by their openings can also be reduced by implementation of a so-called choke structure and/or by absorbent materials located outside the resonator. The device according to the invention is not only suitable by itself as a curing device and/or fuser, but could also advantageously be utilized as a preheating device for the subsequent fusing device. It would also be suitable as a conditioning device for conditioning the print substrate, especially in the case of paper. The print substrate can then already be modified by heat application prior to the start of the printing process.

Use of at least one resonator is preferred, having a length of between 1 and 20 cm in the direction of movement of the print substrate, in order to simplify maneuvering of the latter, or, alternatively, nevertheless enabling a sufficient output (e.g. 1-10 kW per resonator) without giving rise to voltage breakdowns. The width of the resonator should also be adapted to the speed of the print substrate. This is a relative speed (e.g up to 100 cm/s), so that in a kinematic reversal, the fusing device could also move in relation to the stationary print substrate, or both components could move at once. Stationary fusing without movement would also be conceivable.

### BRIEF DESCRIPTION OF THE DRAWINGS

In the detailed description of the preferred embodiment of the invention presented below, reference is made to the accompanying drawings, in which:

FIG. 1 illustrates the function trend of the elastic module G′ of a toner as a function of the temperature for definition of the initial temperature of the glass transition of the toner;

FIG. 2 illustrates the measured function trends in accordance with FIG. 1, for a toner according to the invention and two toners according to the state of the art, for comparison purposes;

FIG. 3 is a schematic perspective view of an example of an embodiment of a resonator according to the invention for fusing a toner image;

FIG. 4 shows a preferred arrangement of 8 resonators within a device according to the invention, for fusing a toner image, in two rows, in a schematic top view;

FIG. 5 shows a second arrangement of 7 resonators, arranged in a V-configuration, shown in a schematic top view;

FIG. 6 is a third arrangement of 8 resonators within a device according to the invention, for fusing a toner image, offset in a stepped configuration, shown in a top view; and

FIG. 7 is a perspective view of a resonator in accordance with FIG. 3 with connectors.

### DETAILED DESCRIPTION OF THE INVENTION

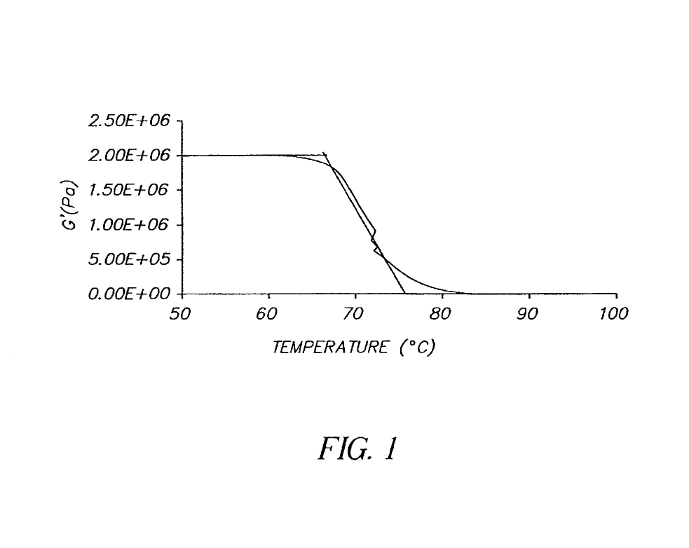

The G′ ratio is the relationship of the elastic module G′, at the initial temperature of the glass transition plus 50° C., to G′ at the initial temperature of the glass transition. The initial temperature of the glass transition is determined in accordance with FIG. 1 from the intersection of the tangents to G′ before and after the glass transition and is situated at just on 70° C. in the example shown.

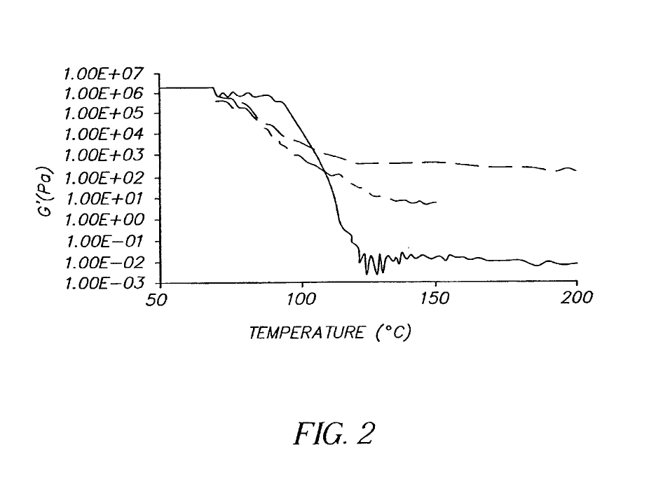

FIG. 2 shows the measured function trend of G′ in accordance with FIG. 1 for three toners used as examples. The values of the function G′ were determined by theological measurement with a Bolin rheometer equipped with parallel plates of 40 mm in diameter. A continuous temperature change with a frequency of 1 rad/s corresponding to 0.16 Hz between 50° C. and 200° C. was implemented. The tension (strain) of the measurement was chosen so as not to cause any thinning due to propulsion (Newtonian behavior). Only the toner according to the invention shows a sharp transition from the solid to the liquid state with a final G′ value of approximately 1.00E-02. This results in a G′ ratio of 5.0E-08.

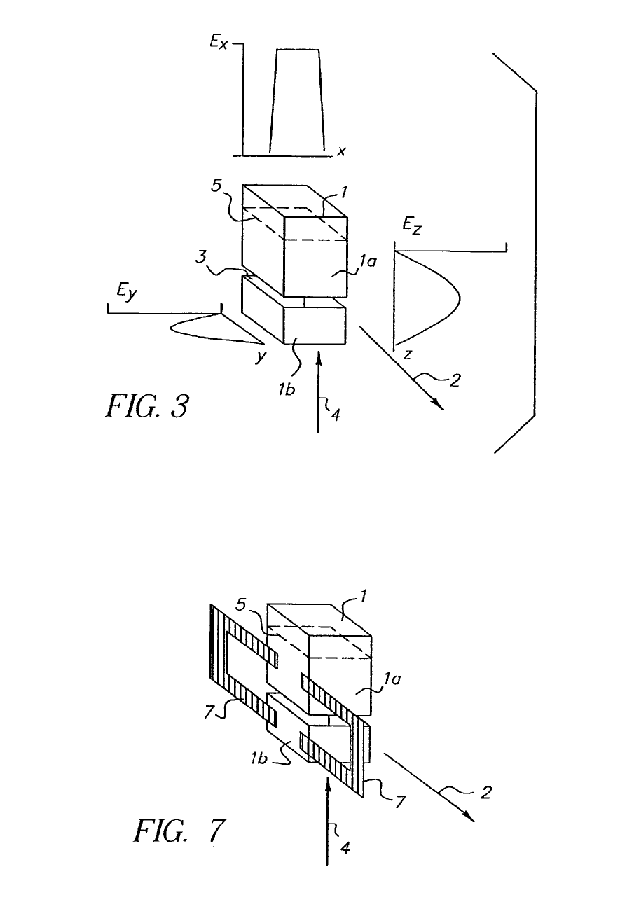

FIG. 3 shows a schematic perspective view of a resonator 1, which in accordance with the invention is positioned vertically to the transport plane of a print substrate not particularly identified, to be transported in the transport direction 2 through a separation gap 3 of the resonator 1. Separation gap 3, which simultaneously determines the transport plane of the print substrate, divides the resonator 1 into sections 1a and 1b. The microwave supply to resonator 1 from a microwave source can take place in the direction of arrow 4, and a movable closure slide 5 is indicated in section 1a of the resonator. A system of coordinates with an x-axis, a y-axis and a z-axis is shown around the resonator 1 in FIG. 3, for orientation of the resonator 1 therein. The direction of transport 2 for the print substrate coincides with the y-axis, the width of the print substrate extends in the direction of the x-axis and the direction of excitation of the standing microwave in resonator 1 extends vertically in the direction of the z-axis.

The intensities Eₓ, E_{y} and E_{z} of the components of the electrical fields of the resonator resulting as a function of the relevant coordinate are qualitatively indicated over the axes of the coordinate system. It can be seen that the development of the intensity of the electrical field Eₓ in the direction of the x-axis, i.e. in the direction of the width of the print substrate is almost at right angles, which means that the said intensity is substantially constant and/or homogenous over the entire width of resonator 1. This causes a heating of the toner bearing print substrate that is proportional to the intensity distribution, with the print substrate being homogenously heated during its transportation in the direction of transport 2 over the x-width of the resonator 1. However, the x-width of the resonator 1 is limited by the circumstance that the field distribution changes with an excessive increase in width. This could result in the heating profile in the direction x no longer being homogenous. Therefore the x-width of the resonators 1 should be limited to less than 20 cm, and preferably be of approximately 4 to 8 cm.

It is therefore necessary to arrange several resonators over the width of the print substrate in order to encompass the entire x-width of the print substrate. An offset arrangement of the resonators 1 further provides the advantage that the resonators can be arranged so that there is enough space between them to house guide elements for the print substrate. In this manner the print substrate can always be maintained in mechanical contact with the guide device. This ensures proper guiding.

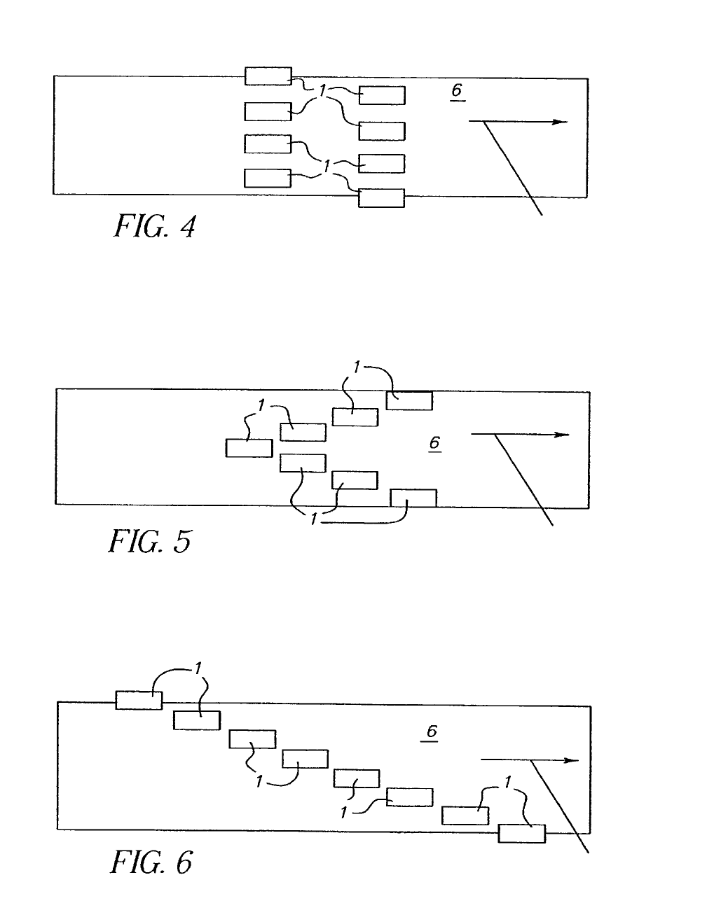

FIGS. 4 to 6 each show, in a schematic top view, preferred arrangements of resonators I in order to heat a print substrate homogeneously over its entire width. Indicated under the shown operating areas of the resonators is a conveyor belt 6 that moves in the direction of transport 2 and is designed to carry the print substrate and transport it through the separation gap 3 of the resonators 1. FIG. 4 shows a particularly compact arrangement. The resonators 1 are each arranged by fours in a row next to one another and in two rows after one another, in relation to the direction of transport 2, with the resonators 1 arranged in each case in the resulting gaps. In FIG. 5 the resonators 1 are arranged offset behind one another in a V-shaped configuration with the entire set of resonators 1, again covering the entire width of the conveyor belt 6. In FIG. 6 the resonators 1 are arranged behind one another in a stepped offset manner, and again in turn covering the entire width of the conveyor belt.

In the three FIGS. 4 to 6 the lengthwise edges of the resonators 1, which each in succession cover the next section of the width of the conveyor belt 6, are drawn aligned to each other. However, for homogenous heating of the toner bearing print substrate it is better if the operating widths of the resonators 1 and the operating areas scanned by them overlap. An overlap of this type can advantageously have a width of 1 to 30 mm, and preferably of 1 to 10 mm. The preferred number of resonators 1 is then dependent on the width of each individual resonator 1, the size of the overlap area and the width of the print substrate and/or of the conveyor belt 6. For example, in accordance with the arrangement in FIG. 4, for a sheet of paper acting as the print substrate and having a maximum width of 383 mm, 8 resonators can be arranged in two rows of four resonators 1 each. Each of these resonators 1 can have an operating width transversal to the direction of transport 2 of 54 mm. The two rows of resonators 1 can be positioned at a distance to each other of 525 mm in the direction of transport 2. Transversally to the direction of transport 2, the resonators 1 of the two rows can be arranged in a gap configuration, with an offset of 47 mm to each other. Taking into account the operating width indicated, this results, in each case, in an overlap of 7 mm of the operating widths in the direction of transport 2 of subsequent resonators.

The arrangements in accordance with FIGS. 5 and 6 also have the advantage that the toner in the overlap areas of the resonators 1 does not cool down during the transition from the operating area of one resonator 1 to that of the next during conveyance of the print substrate in the transport direction 2. This prevents possible visible border layer formations due to renewed melting of the toner layer in the overlap areas of the resonators 1. The arrangements in accordance with FIGS. 5 and 6 are also optimized so that only a minimal area does not come into a contact with the guide arrangement for the print substrate.

FIG. 7 again shows a schematic perspective view of a resonator 1 in accordance with FIG. 3, now with electrically conductive connector elements 7 for connection of sections 1a and 1b of the resonator 1. This assures the electrical connection of sections 1a and 1b, enabling the flow of equalizing currents.

The invention has been described in detail with particular reference to certain preferred embodiments thereof, but it will be understood that variations and modifications can be effected within the spirit and scope of the invention.

What is claimed is:

1. A process for fusing toner onto a carrier or a print substrate, in particular a sheet-like print substrate, preferably for a digital printing machine, wherein the print substrate carrying the toner is irradiated with microwaves from at least one microwave emitter and is heated in order to melt the toner, and that a toner is used that demonstrates a sharp decrease of the elastic module G′ from its solid to a liquid state upon heating.

2. The process according to claim 1, wherein the ratio of the value of the elastic module G′ at the reference temperature value, calculated from the initial temperature at the start of the glass transition of the toner plus 50° C., to the value of the elastic module at the start temperature is <10⁻⁵, preferably <10⁻⁷.

3. The process according to claim 2, wherein the transition of the toner from its solid to its liquid state takes place in a temperature interval of approximately 50° C. or less.

4. The process according to claim 3, wherein the above-mentioned temperature interval of the change in physical state of the toner occurs at above 60° C., preferably in the range of approximately 75° C. to approximately 125° C.

5. The process for fusing toner, in particular according to claim 2, wherein at least one physical procedural parameter is controlled and regulated as a function of a parameter correlated with the energy input into the print substrate carrying the toner.

6. The process according to claim 5, wherein the output of the microwave emitter is regulated as a function of the energy input so that in the event of insufficient energy input the output is increased and in the event of excessive energy input the output is reduced, in order to obtain on average a substantially constant and appropriate energy input.

7. The process according to claim 5, wherein the speed of the movement of the print substrate through an area irradiated with the above-mentioned microwaves is regulated as a function of the energy input, so that in the event of insufficient energy input the print substrate is fused at a lower speed and in the event of excessive energy input the print substrate is fused at a higher speed.

8. The process according to claim 5, wherein the microwave emitter is tuned as a function of the energy input and/or of the frequency of the microwaves emitted therefrom.

9. The process according to claim 5, wherein the parameter chosen to correlate with the energy input is the temperature of the print substrate.

10. The process according to claim 5, wherein the parameter chosen to correlate with the energy input is the energy input coefficient.

11. The process according to claim 10, wherein the parameter measured as correlating with the energy input is the reflected output or energy of the resonator wholly or partially containing a print substrate, and that it is compared to or determined as a ratio of the output generated by the microwave emitter.

12. The process according to claim 2, wherein a frequency is chosen within a microwave frequency range of 100 MHz to 100 GHz outside of the ISM released frequencies, in which the portion of the absorption of the microwave energy by the toner as measured against the total absorption is chosen so as to favor a higher toner absorption.

13. The process according to claim 2, wherein a color toner is used.

14. A device for fusing toner onto a carrier or a print substrate, in particular onto a sheet-like print substrate, preferably for a digital printing machine, preferably for performing the process according to claim 2, wherein at least one microwave emitting source is provided for the irradiation and heating of a toner demonstrating a strong decrease in the elastic module G′ from its solid to its liquid state upon heating.

15. The device according to claim 15, wherein at least one operating parameter influencing the irradiation can be adjusted as a function of a parameter correlating with the energy input into the toner-print substrate system.

16. The device for heating the print substrate or the toner, in particular for fusing toner, preferably according to claim 15, wherein at least one resonator for microwaves emanating from the emitter (microwave source) is provided, generating a standing microwave approximately vertically to the plane of the print substrate.

17. The device according to claim 16, wherein more than one resonator is used and the resonators are arranged distributed over the width of the print substrate.

18. The device according to claim 16, wherein more than one resonator is used and the resonators are arranged set off from one another.

19. The device according to claim 18, wherein the resonators are arranged having mutually overlapping operating widths.

20. The device according to claim 16, wherein the absorption of microwave energy by the print substrate in the subsequent resonators can be optimized in the event of previously occurring resonators being present.

21. The device according to claim 17, wherein the width of the resonator transversally to the path of the print substrate is chosen so that a relatively homogenous microwave field intensity is assured over the said width.

22. The device according to claim 21, wherein the resonator has a width of up to approximately 20 cm, preferably of approximately 4 to 8 cm.

23. The device according to claim 22, wherein the length of the resonator in the direction of transport of the print substrate is of approximately 1 to 20 cm.

24. The device according to claim 17, wherein several resonators, and preferably two resonators are connected to one joint microwave source for a joint effect.

25. The device according to claim 24, wherein the degree of fill of the resonators connected with one and the same microwave source is symmetrical and/or always constant.

26. The device according to claim 15, wherein the device is designed for a multicolor printing machine or constitutes an element of such multicolor printing machine operating on the basis of an electrophotographic printing process.

27. The device according to claim 15, wherein measures are taken to reduce scattered radiation.

28. The device according to claim 27, wherein the sections of a resonator that are separated by the transport path of the print substrate leading through them are connected by an appropriate connector capable of electrical conductivity.
